(19) United States
(12) Patent Application Publication
(10) Pub. No.: US 2004/0119967 A1
(43) Pub. Date: Jun. 24, 2004

(54) Device, system and method for measuring the inverse fine structure constant

(75) Inventor: George A. Soli, Vancover, WA (US)

Correspondence Address: CHRISTIE, PARKER & HALE, LLP, P.O.BOX 7068, PASADENA, CA, 91109-7068, US

(73) Assignee: Integrated Detector Systems, LLC

(21) Appl. No.: 10/682,634

(22) Filed: Oct. 8, 2003

Related U.S. Application Data
(63) Continuation-in-part of application No. 09/863,778, filed on May 23, 2001.

(51) Int. Cl. G01P 3/36

(52) U.S. Cl. 356/28

(57) ABSTRACT

A device, system and method for measuring the inverse fine structure constant using cosmic compass technology to provide sidereal group and phase velocities is presented. The measured daily oscillation of the phase velocity can then be utilized to measure the inverse fine structure constant. A system and method for detecting the cosmic microwave background Doppler redshift direction is also provided as cosmic compass technology as well as a device which can be utilized as a calendar and/or a clock.

### CROSS-REFERENCE TO RELATED APPLICATIONS

This application is a continuation-in-part of U.S. patent application Ser. No. 09/863,778, filed May 23, 2001, the contents of which are incorporated herein.

### FIELD OF THE INVENTION

The present invention is directed to a device, system and method for measuring the inverse fine structure constant.

### BACKGROUND OF THE INVENTION

This invention relates in general to superluminal or faster than the speed of light photon group velocity and to subluminal photon phase velocity that are sidereal and in particular to a device, system and method for measuring the inverse fine structure constant.

Einstein first introduced the idea of an ultimate particle speed known as c, the speed of light, with the publication of his special theory of relativity in 1905. Since this publication, scientists have shown that c is not an upper-limit on a particles speed, but a barrier to acceleration. These mathematical studies have shown that while it is not possible to accelerate an object to a velocity faster than light, it is possible for an object to have a velocity greater than c.

The first evidence of energy moving at velocities greater than c was observed by radio engineers at the turn of the century. They learned that radio signals in the upper atmosphere traveled faster than light. The reason was that the radio waves were moving through ionized gas and not normal air. In effect, these radio wave pulses have two different velocities, a group velocity, or the velocity of the pulse packet, and a phase velocity, the velocity of the individual waves within the group. In this example, the phase velocity of the radio waves, or the internal velocity of the individual waves within the radio wave pulse packet were moving faster than light. A more complete discussion of these early superluminal radio wave experiments can be found in the text Faster Than Light, by Nick Herbert, pg. 56-58, (1988).

Systems designed to transmit energy at superluminal velocities are also well-known in the art of quantum mechanics. One type of conventional superluminal energy transport method employs the phenomenon known as quantum barrier penetration, or tunneling. Under quantum theory, a quantum particle can be thought of as a wave packet, its width in space related to its velocity through the Heisenberg Uncertainty Relation. A common interpretation of this wave packet is that it represents a probability distribution. This means that where the amplitude of the wave packet is the greatest corresponds to the position in space with the highest probability of finding, or measuring, the particle. When the quantum wave packet is incident upon a barrier, it is partially reflected off the barrier and partially transmitted through the barrier. Since the packet transmitted through the barrier is a portion of the original probability distribution there is a small but finite probability of measuring the location of the quantum particle on the far side of the barrier. This phenomenon is known as tunneling and is well-known and accepted. However, a question arises as to the time required for the particle to achieve barrier penetration.

Several groups studying the phenomena of tunneling have shown that the tunneling velocities, or interaction times, for a variety of particles to pass through a barrier exceed c. For example, superluminal velocities have been measured for light pulses traveling through an absorbing material. Superluminal velocities have also been measured for the propagation for microwaves through a forbidden zone inside square metal waveguides. For a more detailed discussion of these experiments see, NEW SCIENTIST, vol. 146, pg. 27 (1995).

More recently, a group at the University of California at Berkeley measured superluminal tunneling-times for visible light tunneling through a dielectric mirror using a Hong-Ou-Mandel interferometer. Similar experiments by a group in the University of Vienna in 1994 confirmed the Berkeley study and also showed that superluminal tunneling times could be obtained for increasingly large barrier thicknesses. For a more detailed discussion of these experiments see, NEW SCIENTIST, vol. 146, pg. 29 (1995).

Finally, in 1995, a group headed by Prof. Nimtz sent a microwave signal broadcasting Mozart's 40^{th} Symphony across 12 cm of space at 4.7 times the speed of light. For a more detailed discussion of this experiment see, NEW SCIENTIST, vol. 146, pg. 30 (1995).

While these experiments and texts clearly show the possibility of transmitting various forms of electromagnetic radiation faster than the speed of light, thus far the cosmic compass is the only system that has been developed to use these superluminal energy transmissions to provide a detection of the cosmic microwave background Doppler redshift direction.

Despite these developments, thus far no system has been developed to use these sidereal energy transmissions to provide a fundamental measurement of a universal constant.

### SUMMARY OF THE INVENTION

The present invention is directed to a device, system and method for measuring the inverse fine structure constant using cosmic compass technology to provide sidereal quasi photon lifetimes and sidereal photon group and phase velocities.

This invention utilizes cosmic compass technology to provide sidereal photon phase velocity. The sidereal photon phase velocity is used to track the RG (Renormalization Group) flow from the boundary space-time into the bulk space-time to a caustic fixed point that is parameterized by the inverse fine structure constant. Using cosmic compass technology sidereal superluminal group velocity can be used to detect cosmic microwave background Doppler redshift direction.

In one embodiment, the cosmic compass technology is utilized to measure the fine structure constant. In such an embodiment the sidereal subluminal phase velocity is observed to flow with the RG to the inverse fine structure constant as the cosmic compass swings into the cosmic microwave background Doppler redshift direction.

In still another embodiment, the apparatus for measuring the inverse fine structure constant is designed to be used as a teaching tool for demonstrating bulk-AdS₅ (5-dimensional anti-de Sitter) space-time electromagnetic caustic physics, boundary electromagnetic Planck scale physics, Cauchy horizon physics in the compact-S⁵ (5-dimensional sphere) space, and 10-dimensional string physics.

In yet another embodiment, the apparatus for measuring the inverse fine structure constant is designed to be used as a teaching tool for demonstrating how holographic information is stored on boundary UV CFT₄ space-time (Ultra-Violet 4-dimensional Conformal Field Theory) at the von Neumann entropy at one bit per Planck area that becomes the maximum Shannon entropy at one bit per Nyquist sample spacing after the irreversible RG (Renormalization Group) flow into the bulk AdS₅ space-time.

In still yet another embodiment, the apparatus for measuring the inverse fine structure constant is designed to be used as a teaching tool for demonstrating how holographic information is mapped by the one dimensional information density Equation (Δx=l_{P}²/m) into the IR (Infra-Red) bulk AdS₅ space-time defining the local electromagnetic caustic at the Nyquist mass scale m, where l_{P} is the Planck length and Δx is the Nyquist sample spacing.

In still yet another embodiment, the apparatus for measuring the inverse fine structure constant is designed to be used as a teaching tool for demonstrating that Nyquist sample spacing in the bulk is dual to the Planck length on the boundary.

In still yet another embodiment, the apparatus for measuring the inverse fine structure constant is designed to be used as a teaching tool demonstrating how the inverse fine structure constant equals the Cauchy horizon in the compact S⁵ space through UV/IR mixing.

In still yet another embodiment, the apparatus for measuring the inverse fine structure constant is designed to be used as a teaching tool for demonstrating how superluminal energy flow is causal, unitary, and luminal through warped space-time.

In still yet another embodiment, the transmission source comprises a radio source in signal communication with a transmission antenna and the receiver comprises an amplifier in signal communication with a receiver antenna.

In still yet another particular embodiment, the invention is directed to a method for measuring the inverse fine structure constant. The method comprising measuring the tunneling phase (bandlimit) time using cosmic compass technology as described above.

### BRIEF DESCRIPTION OF THE DRAWINGS

These and other features and advantages of the present invention will be better understood by reference to the following detailed description when considered in conjunction with the accompanying drawings wherein:

FIG. 1 is a schematic view of hardware embodiment of the cosmic compass and fine structure constant measurement device according to both inventions.

FIG. 2 is a graphical representation of the the L/c free photon time and the 2002 data tunneling time calibration of 5.97 ns in a Bragg mirror at L=190 cm.

FIG. 3 is a graphical representation of the conservation of energy properties of the invention.

FIG. 4 is a graphical representation of the TDC spectrum properties of the invention.

FIG. 5 is a graphical representation of the minimum lower bound properties of the cosmic compass invention with the RG flow already and continuously at the bulk caustic that is later discovered to be the inverse fine structure constant.

FIG. 6 is a graphical representation of the Peaking time sidereal oscillation minimums on April 25 (solid line), May 15 (dashed line), and November 7 (dotted line). Computed redshift direction standard and daylight times are also shown, showing the cosmic compass in operation.

FIG. 7 is a schematic representation of the RG flow from near the boundary CFT₄ to the bulk AdS₅ caustic using the present invention.

FIG. 8 is a graphical representation showing the photon phase velocity (bandlimit time) flow with the RG to the caustic at the inverse fine structure constant (gₜₜ=137.036). The peaking time standard deviation (τₚ(std)) equals the bandlimit time at the electromagnetic caustic at the amplitude of about (0.2 ns).

FIG. 9 is a graphical representation of the cosmic compass technology from the previous invention using the present invention showing the measured peaking time minimum at the computed redshift time where the amplitude of the sidereal oscillation is about (±0.2 ns).

### DETAILED DESCRIPTION OF THE INVENTION

The present invention is directed to a cosmic compass device for measuring the inverse fine structure constant.

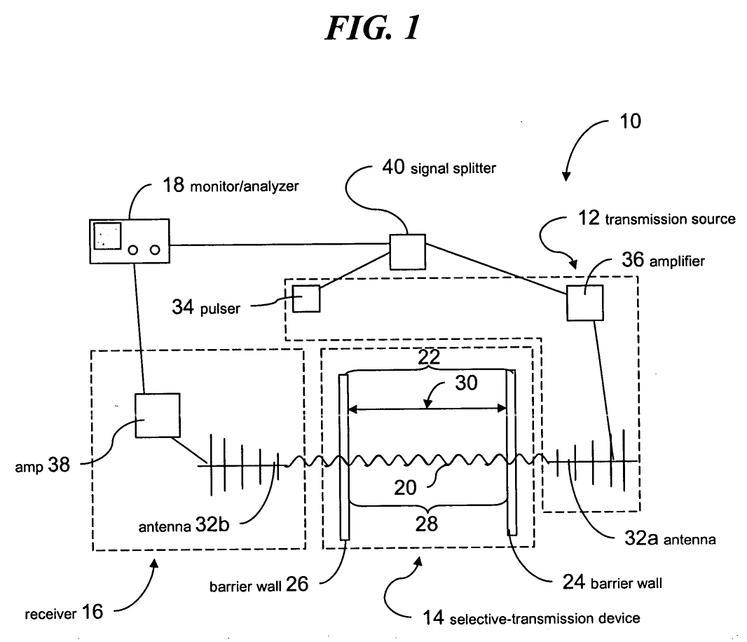

In one embodiment, as shown in FIG. 1, the cosmic compass device 10 comprises a transmission source 12, a quantum tunnel 14 adapted to receive a transmission from the transmission source 12, a receiver 16 in signal communication with the quantum tunnel 14 and a monitor 18 adapted to communicate the transmission to a user.

A transmission wavepacket 20 having a wavefront component is introduced into the quantum tunnel 14 from the transmission source 12 such that the transmission wavepacket 20 is conducted through the space between the transmission source 12 and the receiver 16 to the monitor 18 at velocities faster than the speed of light. The quantum tunnel 14 is placed in proximate relation to the transmission source 12 such that the transmission wavepacket 20 passes through the quantum tunnel 14 and the wavefront component of the transmission wavepacket 20 is transmitted into the receiver 16 creating a signal. A receiver or series of receivers 16, are adapted to receive the signal and transmit the signal to a monitor 18 in signal communication therewith. Any device having the ability to detect changes in amplitude, frequency, phase or wavelength of the transmission 20 can be used as a receiver 16 and monitor 18, such as, for example, a radio amplifier in signal communication with an oscilloscope or a Time to Digital Converter (TDC). Additionally, any suitable transmission source 12 may be used in the subject invention, such as, for example, a microwave generator or a radio transmitter so long as detectable levels of electromagnetic radiation are transmitted to the receiver 16 in the form of a transmission wavepacket 20.

In general terms, the quantum tunnel 14 comprises a quantum air-gap barrier 22, such as a Bragg mirror constructed with two water tanks separated by an air-gap. The air-gap length is adjusted to the minimum Poynting vector, defining a Bragg mirror, which is in signal communication with the transmission source 12. The quantum air-gap barrier 22 comprises a proximal 24 and distal 26 barrier wall and an air-gap 28 having a tunneling, or air-gap, length 30 disposed therebetween. The proximal barrier wall 24 is in signal communication with the transmission source 12 and the distal barrier wall 26 of the air-gap barrier 22 is in signal communication with the receiver 16. The transmission 20 from the transmission source 12 interacts with the air-gap barrier 22 which transmits the wavefront component of the transmission wavepacket 20 across the air-gap 28 to the receiver 16 at subluminal velocities. The air-gap barrier 22 generates superluminal transmission velocities in the wavepacket group component of the transmission 20 by selecting the wavefront component of the transmission wavepacket 20 and more efficiently transmitting that wavefront component across the air-gap 28. The wavefront component of the transmission wavepacket 20, is selected by arranging the proximal 24 and distal 26 barrier walls such that the air-gap length 30 therebetween corresponds to quarter wavelength or multiples thereof of the wavefront component of the transmission wavepacket 20. By selecting the air-gap length 30 to correspond to the wavelength of the wavefront component of the total transmission wavepacket 20, the air-gap barrier 22 provides the wavefront component of the transmission wavepacket 20 a head start, in effect causing tunneling of the wavefront component, or tunneling transmission across the air-gap 28 in a tunneling time that is independent of the tunnel distance, or air-gap length, 30, thus causing the tunneling transmission to cross the air-gap 28 at a superluminal group velocity. Any air-gap barrier 22 construct suitable for selecting the wavefront component of the transmission wavepacket 20 from a transmission source 12 and transmitting the wavefront component of the wavepacket 20 across an air-gap 28 at subluminal velocities with a headstart causing superluminal group velocities may be used such as, for example, square metal waveguides for microwave transmissions or tanks having a high index of refraction substance such as water for radio transmissions.

In one preferred embodiment, a radio transmission source 12, a radio receiver 16 and an air-gap barrier 22 comprising a proximal tank 24 and a distal tank 26 aligned parallel to each other across an air-gap 28 are utilized to generate the superluminal transmissions. The proximal tank 24 is placed in signal communication with the transmission source 12 and the distal tank 26 is placed in signal communication with the receiver 16. The tanks 24 and 26 are arranged such that an air-gap 28 is created between having an air-gap length 30. In this embodiment, the tanks 24 and 26 may have any index of refraction suitable to act as a quantum barrier such as, for example, a Plexiglas™ tank filled with water.

To transmit the transmission wavepacket 20 to and from the quantum tunnel 14, the transmission source 12 and receiver 16 must be positioned relative to quantum tunnel 14 such that the transmission wavepacket 20 passes through the quantum tunnel 14. In the embodiment shown in the attached figures, a radio transmission source 12 and a radio receiver 16 utilize antennas 32 directed at the quantum tunnel 14. However, any suitable design can be used such that the transmission 20 from the transmission source 12 passes through the quantum tunnel 14 and enters the receiver 16.

A prototype of the superluminal transmission device 10 described above was constructed. A NIM-logic pulser 34 (Phillips Scientific model 417 Nuclear Instrumentation Standard Pocket Pulser) in signal communication with an amplifier 36 (RadioShack catalog # 15-1113C) is used as the transmission source 12 and is placed in signal communication with a five-element folded-dipole Yagi antenna 32a designed for two-meter wavelength radio waves. A second amplifier 38 (RadioShack catalog # 15-1170 or equivalently # 15-1113C set at minimum gain) in signal communication with a second five-element folded-dipole Yagi antenna 32b is used as the receiver 16. Both antennas 32a and 32b comprise 3 inch aluminum ground wire reflector and deflectors, and a #10 copper wire folded dipole. 75 ohm to 300 ohm transformers, (RadioShack catalog # 15-1140), are connected to 75 ohm cables at the antennas 32a and 32b. Each antenna 32a and 32b is also surrounded by an aluminum screen (not shown), with a 114 cm wide opening along the folded-dipole direction to selectively transmit and receive a signal wavelength at less than or equal to 228 cm. The signal from the receiver amplifier 16 is fed into an oscilloscope monitor 18 (Tektronix TDS220). Alternatively a TDC could be utilized as a monitor 18, such as, for example, an ORTEC 9308 Picosecond Time Analyzer preceded by a 9307 pico-Timing Discriminator. The transmission source 12 signal is also monitored by the oscilloscope monitor 18 via a signal splitter 40 which is placed in signal communication with the radio-wave pulser 34. The cables leading from the transmission source 12 and the receiver 16 to the oscilloscope monitor 18 are terminated into 75 ohms.

The quantum tunnel 14 comprises an air-gap barrier 22 having proximal 24 and distal 26 barrier walls arranged such that an air-gap 28 lies therebetween. The proximal 24 and distal 26 barrier walls consist of two 4 ft wide and 2 ft high distilled water tanks. The distilled water layer thickness in each tank is 12.7 mm or 0.5 inch and the index of refraction is n=9 and k=0.002. The water tanks are constructed with quarter inch thick Plexiglass having an index of refraction of n=1.6 and k=0.0.

During operation of the apparatus a pulser signal is split into two cables. The one leading directly to the Time to Digital Converter (TDC) is used to start the TDC. The other cable leads, through an amplifier, to the transmitting antenna. The transmitting and receiving antennas are identical five-element folded-dipole Yagi antennas designed for two-meter wavelength radio waves. Each antenna is surrounded by aluminum screen except for openings at the antenna ends that are 114 cm wide (along the folded dipole direction), bandlimiting the wavepacket. This opening is slightly smaller than the 122 cm or 4 feet wide water tanks. The transmitter and receiver folded-dipoles are held fixed at 4.9 meters apart.

The TDC is a 9308 Picosecond Time Analyzer preceded by a 9307 pico-Timing Discriminator (before the stop TDC input) from ORTEC™. The pulser is a battery powered Phillips Scientific™ Model 417 NIM Pocket Pulser. The transmitting and receiving amplifiers are from RadioShack™ catalog number 15-1113C. The pulser is connected through a signal splitter, catalog number 15-1234, to the input of the transmitting amplifier. 300-ohm to 75-ohm transformers, catalog number 15-1140, connect to 75-ohm cables at the antennas. The cable lengths are adjusted so that the pulser TDC start pulse arrives at the TDC just prior to the wavepacket fronts.

In the Cosmic compass invention and in the current invention the superluminal group velocity and the average speed of energy flow of photon wavepackets is measured for two-meter wavelength photons tunneling through a water mirror. The advantage of using long wavelength photons, as opposed to the optical or short wavelength photons used in the prior art, is that one is able to measure the small sidereal effects that are the one-way superluminal group and subluminal phase velocities of light that scale with the wavelength. The sidereal one-way, superluminal group velocity was first predicted by Reichenbach as the relativity of simultaneity for superluminal energy flow [[1] H. Reichenbach, The Direction of time, M. Reichenbach Editor, Dover Publications, Mineola N.Y. 1999]. Changing Shannon entropy with renormalization group flow as described by Fujikawa [[2] K. Fujikawa, “Remarks an Shannon's Statistical Inference and the Second Law in Quantum Statistical Mechanics”, arXiv:cond-mat/0005496 v4 Apr. 1, 2002] in turn causes the subluminal phase velocity to be sidereal.

Accordingly, the electromagnetic pulse energy arrival time and group velocity only involves the Poynting vector and is given by the time expectation integral over the incoming Poynting flux. The energy arrival time is defined as the time “center of mass” and is suitable for describing the energetic classical electromagnetic pulses used here. The complex part of the index of refraction is small and the measured group delay involves only the real part of the index of refraction as described by Peatross, Glasgow, and Ware [[3] J. Peatross, S. A. Glasgow, and M. Ware, “Average Energy Flow of Optical Pulses in Dispersive Media”, Phys. Rev. Lett. 84, 2370 (2000)]. In summary, the classical electromagnetic superluminal energy pulse cannot get past its luminal wavefront and is superluminal only inside the wavepacket as described by Chiao [[4] R. Y. Chiao, “Tunneling Times and Superluminality: a Tutorial”, arXiv:quant-ph/9811019, Nov. 7, 1998], and the sidereal velocities of light are statistical and do not exist near the wavefront as previously measured and as described by Will [[5] C. Will, “Clock synchronization and isotropy of the one-way speed of light”, Phys. Rev. D 45, 403 (1992)].

It is generally interpreted that the superluminal energy flow only exists to “pay back” energy borrowed from the vacuum. Photons do not self interact, and require optical coatings (the water mirror in this experiment) to form quasi-photons. The quasi-photons exist for a tunneling time (Δτ) defined by Heisenberg's time-energy uncertainty principle (ΔτΔE≧h/2), as described by Chiao [4]. In such quasi-photons the quasi-photon energy (ΔE) is equal to the Nyquist energy (ΔE=h/ΔΔτ) where the bandlimit time (ΔΔτ) is defined by Shannon's statistical uncertainty principle (ΔE≦4πh/ΔΔτ) as described by Fujikawa [2]. The measured bandlimit time (ΔΔτ), in turn equals the measured formal standard deviation (τₚ(std)) in the energy peaking time (τₚ), and the bandlimit time is the minimum lower bound in the peaking time formal standard deviation as described by Kempf [[6] A. Kempf, “Fields over Unsharp Coordinates”, Phys. Rev. Lett. 85, 2873 (2000)]. Meanwhile, the measured causal and unitary superluminal energy flow is the renormalization group statistical continuation of Maxwell's equations as described by Delamotte [[7] B. Delamotte, “A hint of renormalization”, arXiv:hep-th/0212049 v2, Jan. 27, 2003].

The classical superluminal electromagnetic group velocity theory that is experimentally demonstrated here, and the history of superluminal group velocity measurements are described by Peatross et. al. [3]. In this theory, the classical superluminal electromagnetic pulse energy arrival time only involves the Poynting vector and is given by the time expectation integral over the incoming Poynting flux. The energy arrival time used for describing the classical electromagnetic pulses used in this experiment is defined by the time-center-of-mass as described by Peatross et. al. [3]. Accordingly, the average classical energy arrival time or time-center-of-mass of (n) voltage peaks in each wavepacket is given by,

$${τ}_{P} \pm {τ}_{P} ( std ) = {\sum }_{k = 1}^{n} {t}_{k} {S}_{k} / {\sum }_{k = 1}^{n} {S}_{k} \pm {τ}_{P} \sqrt{2 {( {\sum }_{k = 1}^{n} {s}_{k} / {\sum }_{k = 1}^{n} {S}_{k} )}^{2}} \qquad ( 1 )$$

where (τₚ) is the energy peaking time (Sₖ) is the Poynting vector of voltage peak (k), (sₖ) is the Poynting vector formal (std) standard deviation, and (tₖ) is the voltage peak's centroid computed using a Gaussian fit to a single peak (k) in the spectrum. It will be observed that the classical energy peaking time (τₚ) defines the photon group velocity. The classical energy peaking time (τₚ) is also given by a Gaussian fit to all of the (n) peaks in a spectrum.

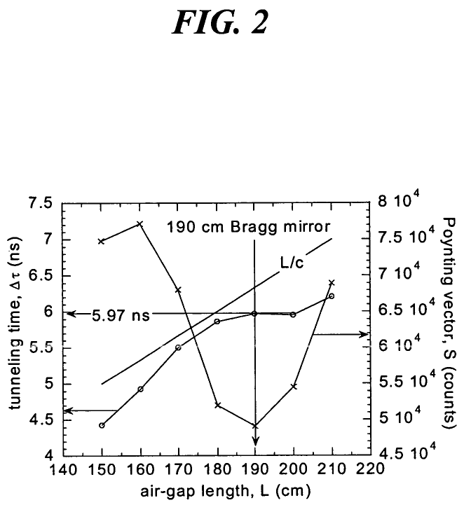

In the experiments conducted, the arrival time difference between the tunneled wavepacket and the pulser is histogrammed by the TDC. Arrival time histograms measuring the voltage peak centroid times (tₖ) and the number of counts under each peak (Sₖ) are collected in 1.6 minutes and 10 histograms are used to compute the formal mean and standard deviation values shown in the data plots. The TDC has a histogramming bin width of 1.22 ps over an 80 ns window. There are 1E6 start and stop counts in each TDC spectrum, except for the calibration data shown in FIG. 2. The 9307 discriminator level is set above the noise but low enough so that every start count has a valid stop count for all data except the calibration data shown in FIG. 2.

The measured peaking time difference (τ_{g}=τₚ−(τₚ)_{FREE}) is defined as the measured group delay time (τ_{g}). The measured tunneling time is (Δτ=(L/c)+τ_{g}) where, (L/c) is the free photon time that is measured with both the water tanks removed and L is the air-gap length as described by Chiao [4].

For example, a measured tunneling time of 5.97 ns is shown in FIG. 2. To calibrate the detector system it is necessary to find where the tunneling time is independent of the air-gap length. This happens at the minimum in the Poynting vector at an air-gap length of 190 cm as shown in FIG. 2.

The cosmic rest frame (Rest Frame=RF) velocity vector is in the direction opposite the Earth's motion that causes the cosmic-microwave-background Doppler redshift. The Cosmic rest frame velocity is β(RF)=0.001237±0.000002 and is a vector that points in the direction of right ascension of 23.20 h and declination of 7.22°, the cosmic microwave background Doppler redshift direction as described by Fixsen [[8] D. Fixsen et. al., Astrophys. J. 473, 576 (1996)] and Hagiwara [[9] K. Hagiwara et. al., Phys Rev D 66, 010001 (2002), Sec. 22.3.1 the dipole (see, URL:http://pdg.lbl.gov)].

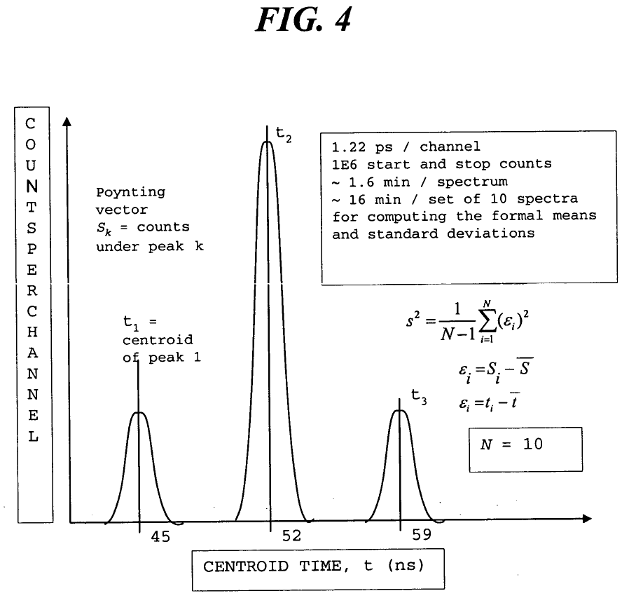

As shown in FIG. 4, there are three peaks (n=3) in each TDC spectrum in the April and May data sets in 2002 and in all 2003 data sets and four peaks (n=4) in the November 2002 data set. The tunneling direction is parallel to the Earth's surface with an azimuth of 80° in Vancouver, Wash. Once per day the Earth's spin rotates the tunneling direction into the cosmic-microwave-background Doppler redshift direction. This direction equivalence between the photon propagation direction through the tunnel and the cosmic-microwave-background Doppler redshift direction happens once per day and the time of this equivalence is sidereal and changes by about four minutes per day and moves around the clock as the Earth moves around the Sun.

For the measured tunneling time of Δτ=5.97 ns, shown in FIG. 2, and the non-relativistic velocity vector addition, the tunneling time sidereal oscillation would be Δτ=5970±7.38±0.59 ps. The ±7.38 ps is the daily sidereal oscillation caused by the Earth's spin rotating the tunneling photon propagation direction into, and out of, the cosmic-microwave-background Doppler redshift direction, and the ±0.59 ps is the yearly change in the daily oscillation due to the Earth's velocity around the sun.

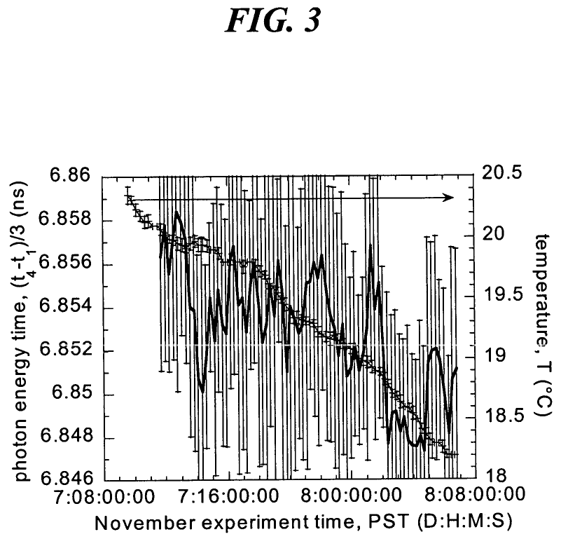

Photon energy, defined by the average centroid time difference (t_{E}=(tₙ−t₁)/(n−1)) for (n) peaks in the TDC spectrum, is not sidereal. This time defines the average time between voltage peaks in the tunneled wavepacket and is plotted in FIG. 3, showing that photon energy is not sidereal and only changes with temperature. The photon energy time shown in FIG. 3 is ((t₄−t₁)/3) because the November 2002 data have four peaks in each TDC spectrum. The temperature is taken every 96 seconds and ten data points are used to compute the formal mean and standard deviation temperature values shown. The November 2002 experiment was engineered to have four peaks in each TDC spectrum to test the wavepacket energy equation (t_{E}=(tₙ−t₁)/(n−1)) for (n>3) peaks in the TDC spectrum. The November 2002 experiment produced 4 peaks in each TDC spectrum by lowering the 9307 discriminator level.

If we assume that tunneling photon energy is isotropic in the cosmic rest frame, defined by zero Doppler shift in the cosmic microwave background, then the tunneling photon's energy time (t_{E}) might have been the group velocity time and have a measurable sidereal oscillation of (t_{E}=t_{E}(average)±7.38±0.59 ps). The measured tunneling photon energy is not sidereal as shown in FIG. 3.

Applicant discovered that the photon group velocity, defined using the peaking time given by Equation 1, is sidereal. Specifically, the peak Poynting vectors, defined as the number of counts under each peak, are sidereal. When the tunneling-photon propagation direction is into the cosmic-microwave-background Doppler redshift direction, there are the most counts under the first peak in the TDC spectrum and the least counts under the last peak. The first peak is shown in FIG. 4, with a centroid time of 45 ns and the last peak with a centroid time of 59 ns. As the tunneling direction rotates out of the redshift direction, the number of counts under the first peak decreases and the number of counts under the last peak increases.

For the 2002 data with three peaks in each TDC spectrum, the measured unequal spacing between the peaks is the bandlimit time ΔΔτ=2[(t₂−t₁)−(t₃−t₂)]. The second and third peaks have the smallest separation between their centroid times because this experiment was engineered so that the highest energy wavepacket component would be near the wavepacket tail.

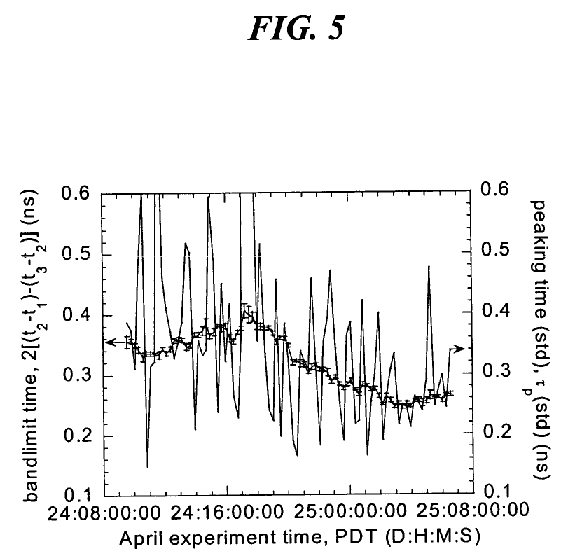

The maximum bandlimit time is the peaking time standard deviation defined in Equation 1. At the maximum Shannon entropy we discover that the bandlimit time is the minimum lower bound in the peaking-time formal standard deviation as shown in FIG. 5. The 2002 experiment was engineered to have the highest energy wavepacket component near the wavepacket tail in order to prove Peatross et. al. theory [3], which states that it does not mater if the highest energy component is near the wavefront or near the wavepacket tail. The 2002 experiment was operated with a minimum gain setting on both Amplifiers (catalog # 15-1113C shown in FIG. 1). The 2003 experiment used increased gain on the transmitting amplifier to zero the bandlimit time at the beginning of the RG flow.

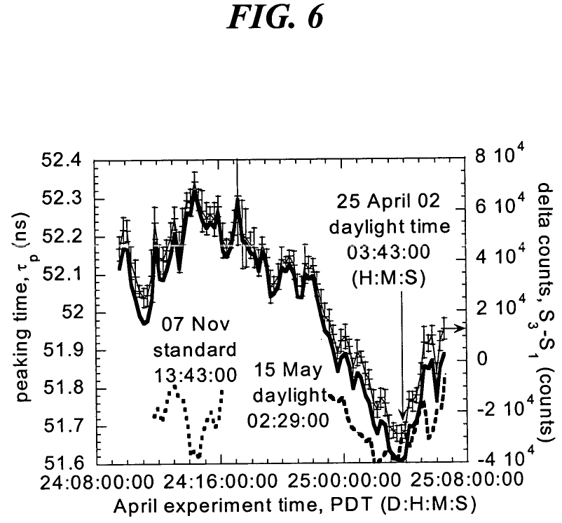

As discussed above, the tunneling time, shown in FIG. 6, detects a direction in space that is equivalent to the cosmic-microwave-background Doppler redshift direction. The Doppler redshift is caused by the Earth's velocity relative to the cosmic-microwave-background rest frame. When the tunneling direction is opposite to the Earth's cosmic velocity the tunneling time is minimum.

Sidereal peaking time 2002 minimums are shown in FIG. 6. The April computed redshift direction time, at 25:03:43:00 (D:H:M:S) Pacific Daylight Time (PDT), is the time that tunneling is into the cosmic-microwave-background Doppler redshift direction on Apr. 25, 2002. The measured minimums in the peaking times are at the computed redshift times as shown in FIG. 6, thus proving the cosmic compass technology claimed in the previous cosmic compass patent by measuring the redshift direction movement. The computed redshift times, and therefore the minimum tunneling-time directions, are sidereal, in that they move around the clock, by about 4 minutes per day, as the Earth moves around the sun. The direction that is detected by the tunneling time minimums is always the same direction, and is equivalent to the cosmic-microwave-background Doppler redshift direction.

The difference in the counts under the first and third peaks is shown in FIG. 6 as delta counts. The standard deviation in the delta counts data is smaller than the peaking-time standard-deviation, showing that the peaking-time sidereal-oscillation is caused by a redistribution in counts under the first and third peaks for the April data set. The large peaking-time standard-deviation suggests that it is made large by a minimum-lower-bound as described by Kempf [6].

The 0.6 ns sidereal oscillation amplitude, shown in FIG. 6 for the April peaking time, is equal to the ±0.3 ns bandlimit time shown in FIG. 5. The bandlimit time equals the peaking time standard deviation (τₚ(std)) shown in FIG. 5 and computed using Equation 1, given above. The centroid time standard deviations, tₖ(Std), are only a few ps and are ignored in the Equation 1 (τₚ(std)) computation.

The superluminal tunneling time (group velocity) sidereal oscillation, shown in FIG. 6, is defined using the Reichenbach coefficients (ε_{C}),

Δτ±ΔΔτ=2ε_{C}Δτ±counting statistics (2)

where the Reichenbach coefficients are independent of the amplitude of Earth's absolute velocity through the cosmos.

The sidereal tunneling time amplitude saturates the minimum-lower-bound in its own formal standard deviation (τₚ(std)) shown in FIG. 5, and is not equal to the Earth's cosmic-microwave-background velocity amplitude, preserving Einstein's relativity principle. However, as shown and discussed above the direction in space is detected even though the amplitude of the sidereal oscillation is engineered using the bandlimit time. Accordingly, solving Equation 2 for the Reichenbach coefficients yields,

$${ϵ}_{C} = \frac{1}{2} - \frac{Δ Δ τ}{2 Δ τ} ( {\vec{n}}_{C} \cdot {\vec{n}}_{T} ) \qquad ( 3 )$$

where (ΔΔτ) is the bandlimit time defined above, (n_{C}) is a unit vector in the Cosmic-redshift direction, and (n_{T}) is a unit vector in the Tunneling direction. Accordingly, it has been shown that the Reichenbach coefficients define the relativity of simultaneity as defined by Reichenbach in reference [1].

While this previous invention clearly shows that transmitting low frequency electromagnetic radiation faster than the speed of light is cosmic compass technology, thus far no system has been developed to use these sidereal energy transmissions to provide a fundamental measurement of a universal constant.

As discussed, the current invention is directed to an apparatus and method for measuring the inverse fine structure constant. In such an embodiment the apparatus is utilized to measure the tunneling photon phase velocity, which can then be used to determine the inverse fine structure constant. As the Earth's daily spin rotates the tunneling photon propagation direction into the redshift direction, and the group velocity approaches its maximum value, the photon bandlimit time (phase velocity) flows with the RG (Renormalization Group) flow to a bulk space-time caustic that in turn measures the inverse fine structure constant.

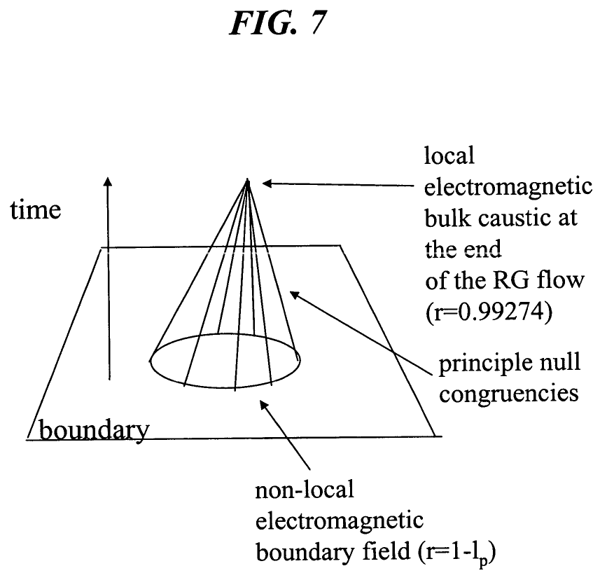

The RG flow is from an extended object (the electromagnetic field) on the boundary CFT₄ (4-dimensional Conformal Field Theory) to a local caustic in the bulk AdS₅ (5-dimensional Anti deSitter) space-time as shown in FIG. 7, and described in [[10] V. Sahakian, “Holography, a covariant c-function, and the geometry of the renormalization group”, Phys Rev D 62, 126011 (2000)]; and [[11] R. Bousso, “The Holographic Principle”, Rev. Mod. Phys. 74 825 (2002); arXiv:hep-th/0203101 v2 Jun. 29, 2002], the disclosures of which are incorporated herein. The tunneling superluminal photon is a quasi-photon that stores energy in the tunnel and is the extended electromagnetic object on the boundary CFT₄ at the beginning of the RG flow and is the local electromagnetic caustic at the end of the RG flow. The fifth dimension is the radial coordinate in the AdS₅ space-time and is into the bulk space-time. The AdS₅ space-time is the open ball AdS₄ space with radial coordinate r<1 and Euclidean time (−∞<t<+∞). The boundary CFT₄ is at r=1 and boundary distances are dimensionless. The metric is given by the equation:

dS²=R²[4gᵣᵣ(dr²+r²dΩ₃²)−gₜₜdt²+dΩ₅²)] (4)

where R=1 on the boundary and in the U(R)=U(1) gauge (gₜₜ=(1+r²)/(1−r²)) re-scales Euclidean coordinate time (t) by a positive factor, (gᵣᵣ=(1−r²)⁻²), (dΩ₃²) is the metric on the 3-dimensional unit sphere (S³), and (dΩ₅²) is the metric on the 5-dimensional unit sphere (S⁵). This is also given in Bousso [11], and in [[12] L. Susskind and E. Witten, “The Holographic Bound in Anti-deSitter Space”, arXiv:hep-th/9805114, May 19, 1998], the disclosure of which is incorporated herein. In turn, the measured RG parameter equals the metric coordinate-time re-scalar (gₜₜ). The measured metric coordinate-time re-scalar is equal to inverse fine structure constant at the end of the RG flow to the local electromagnetic caustic in the bulk AdS₄ space,

gₜₜ=(1+r²)/(1−r²)=137.036=hc/e² (5)

where (r²=ωₘᵢₙ/ωₘₐₓ) and (ΔE=h/[(4π/ωₘᵢₙ)−(4π/ωₘₐₓ)]) is the quasi-photon energy, (e) is the electric charge on the electron, (ΔEΔτ≧h/2) is the Heisenberg's time-energy uncertainty principle, and (Δτ) is the measured quasi-photon lifetime and photon tunneling time. The measured AdS₄ space radial coordinate is r=0.99274 at the bulk caustic, when tunneling is into the cosmic-microwave-background Doppler redshift direction, at the end of the RG flow.

The quasi-photon energy is limited by Shannon entropy. The Shannon uncertainty principle is given by the equation:

ΔE≦4πh/ΔΔτ (6)

where (ΔΔτ=4π[(1/ωₘᵢₙ)−(1/ωₘₐₓ)]) is the bandlimit time. The equation is also described in K. Fujikawa [2], the disclosure of which is incorporated herein. The bandlimit time is the minimum lower bound in the tunneling time, and quasi-photon lifetime, formal standard deviation, at the electromagnetic caustic, at the end of the RG flow, as described in A. Kempf [6], the disclosure of which is incorporated herein. Shannon entropy is maximum at the IR (infrared) caustic and minimum on the UV (ultraviolet) boundary CFT₄ where the Shannon entropy equals the von Neumann entropy on the boundary. The measurable physical quantity is the maximum Shannon entropy at the IR caustic and this entropy corresponds to the fine structure constant, 1/137.036. The maximum Shannon entropy is greater than the von Neumann entropy and the measured RG flow is irreversible.

In the geometric dual AdS₅ gravitational theory, the inverse fine structure constant, 137.036, can be measured that corresponds to the maximum Shannon entropy. The maximum von Neumann information density, in the dual theory, is one bit per Planck area on the electromagnetic black-brane on the boundary CFT₄. The maximum Shannon information density, at the electromagnetic caustic, is the Nyquist sample spacing and is defined by the maximum Shannon entropy.

Very near the boundary CFT₄ the measured bandlimit time almost vanishes and the boundary UV Nyquist energy is almost infinite and is equal to the Planck energy. The Nyquist energy (ΔE=h/ΔΔτ) is the quasi-photon water-tank (vacuum) expectation value that measures the energy scale of the RG flow. The energy scale decreases, from the Planck energy, almost on the UV boundary, to the Nyquist scale at the bulk IR caustic. At the bulk IR caustic, at the end of the RG flow, ΔE=5.275e−18 ergs, the Nyquist sample spacing is about (Δx=cΔΔτ=6.000 cm), and the measured bandlimit time is about (ΔΔτ=0.200 ns). The Nyquist mass-scale in geometric units is (m(Nyquist)=(G/c²)(ΔE/c²)=4.352E−67 cm). Because (Δx=6.000 cm), we discover the following equation by inspection,

Δx(Nyquist)=l_{P}²/m(Nyquist)=(Gh/c³)/[(G/c²)(ΔE/c²)]=cΔΔτ=6.000 cm (7)

where (l_{P}=√(Gh/c³)=1.616E−33 cm) is the Planck length.

In the dual geometric theory, the Nyquist sample spacing (Δx) is the Planck length (l_{P}). This is true because the information content of the IR bulk electromagnetic caustic is one bit per Nyquist sample spacing after the RG flow and the information content (counting in one dimension) of the dual UV boundary electromagnetic black-brane is one bit per Planck length. Therefore,

Δx(Planck)=l_{P}²/m(Planck)=l_{P}²/l_{P}=l_{P}=1.616E−33 cm (8)

If an observer could get within a Planck length of the boundary electromagnetic black-brane, the observer would see a black hole with a Planck mass. If an observer could get within a Nyquist sample length of the bulk electromagnetic caustic, the observer would see a Nyquist energy-scale mass.

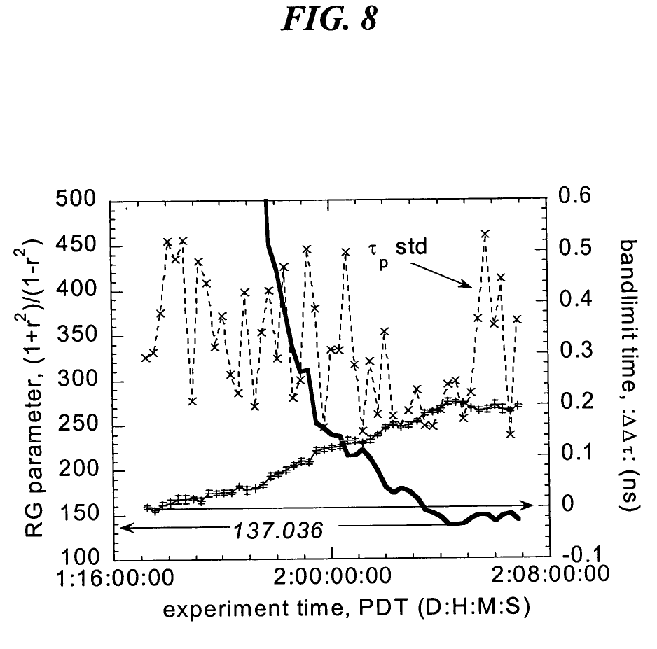

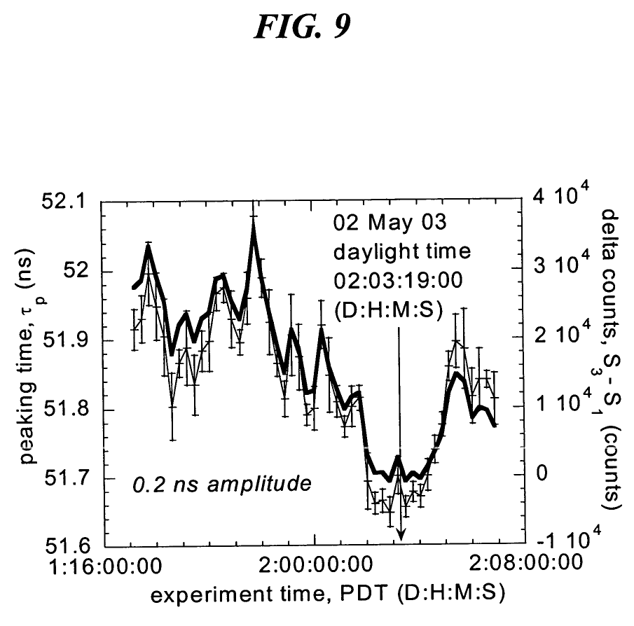

As the measured bandlimit time (ΔΔτ) flows with the RG from 0.0 to 0.2 ns, the measured RG parameter (gₜₜ=(1+r²)/(1−r²)) flows from almost infinity on the boundary CFT₄ at r=1, down to the inverse fine structure constant 137.036 at r=0.99274 shown in FIG. 8. This May 2003 data also shows the photon phase velocity (bandlimit time) flow with the RG to the caustic at the inverse fine structure constant (gₜₜ=137.036). In this plot it is shown that the peaking time standard deviation (τₚ(std)) equals the bandlimit time at the electromagnetic caustic at the amplitude of about (0.2 ns). This data also detects the cosmic-microwave-background Doppler redshift direction at the end of the RG flow shown in FIG. 9. The data shows the measured peaking time minimum at the computed redshift time where the amplitude of the sidereal oscillation is about (±0.2 ns). Again, the redistribution of counts exposes the sidereal physics.

Although these results show sidereal oscillation, causality and unitarity are protected by Reichenbach's principle of common cause, as described in H. Reichenbach [1], which is incorporated by reference herein. The RG flow from the non-local (extended object) electromagnetic field on the boundary CFT₄ to the electromagnetic caustic in the bulk AdS₅ space-time is along converging principle null congruencies. The bulk electromagnetic caustic is on the bulk light cones of every Planck scale point on the boundary electromagnetic field. Therefore, the bulk electromagnetic caustic has a common cause, the boundary electromagnetic field. Accordingly, causal and unitary faster than light (group velocity) technology as described herein is not faster than light, but is equal to the speed of light but through warped (AdS₅) space-time.

Accordingly the apparatus and method in accordance with the current invention, and as shown in FIGS. 8 and 9, demonstrate that the electromagnetic caustic is in the bulk at (r=√(ωₘᵢₙ/ωₘₐₓ)=0.99274) at the inverse fine structure constant (gₜₜ=(1+r²)/(1−r²)=137.036). In addition, it can be demonstrated that tunneling photon propagation is into the cosmic-microwave-background Doppler redshift direction at the end of the RG flow because quasi-photons are holograms as described in [[13] J. Bekenstein, “Information in the Holographic Universe”, Scientific American, August 2003].

Understanding the inverse fine structure constant requires the use of the metric term, that is the 5-dimensional unit sphere (S⁵), as described in Equation 9.1 in Bousso [11]. The whole space-time is now (AdS₅×S⁵) that is the 10-dimensional space-time of string physics.

Using the apparatus, it is possible to observe within a Planck length of the electromagnetic black-brane (black hole) and indeed to descend inside and into the compact S⁵ space with positive unit curvature, however, it is only possible to enter a distance of r(inside(S⁵))=(1−0.99274), before hitting the Cauchy horizon, as described in [[14] T. Levi and S. Ross, “Holography beyond the horizon and cosmic censorship”, Phys Rev D 68, 044005 (2003)], the disclosure of which is incorporated herein by reference.

Beyond the Cauchy horizon, closed timelike curves exist, but it is not possible to observe, because of the infinite blueshift surface at the Cauchy horizon. The dual inverse fine structure constant (dual to the boundary CFT₄) in the bulk AdS₅ space-time is at r(inside(AdS₅))=(0.99274) and is on the infinite redshift surface that is equivalent to the infinite blueshift surface at the Cauchy horizon through UV/IR mixing as described by Susskind and Witten [12] and incorporated herein by reference. The electromagnetic field (black-brane) stays near the boundary CFT₄ at the electromagnetic black hole event horizon. The electromagnetic caustic is a holographic projection into the bulk AdS₅ space-time. The electromagnetic field (black-brane) energy would redshift to zero energy, at r=0.99274, at the electromagnetic caustic, if it propagated there from the boundary.

The electromagnetic caustic has a Nyquist sample spacing of about 6.000 cm and that is as close as our observer can get to the caustic. If the electromagnetic field could probe distances smaller than Nyquist sample spacing, than the superluminal (group velocity) energy flow would violate causality. Likewise if one could get past the infinite blueshift surface inside the electromagnetic black hole, it would be possible to see closed timelike curves that would violate causality, however, causality is not violated because the RG flow stops, at the inverse fine structure constant in the bulk AdS₅, at the Cauchy horizon inside the electromagnetic black hole in the compact S⁵. The Cauchy horizon is equivalent to the electromagnetic inverse fine structure constant in the bulk AdS₅ space-time through UV/IR mixing [12]. The AdS₄ space has negative unit curvature and energy propagation off of the boundary and into the bulk is redshifted. The S⁵ space has positive unit curvature and propagation off of the boundary and into the compact S⁵ space is blueshifted. In very large black holes, like the one at the center of our galaxy, it wouldn't be possible to notice the event horizon passing, but it also wouldn't be possible to miss the infinite blueshift at the Cauchy horizon. Therefore it is natural that the Nyquist sample spacing sized (Δx=6 cm) electromagnetic caustic in AdS₅ is not a point singularity in S⁵, but is a Cauchy horizon in S⁵. In general, Cauchy horizons, not dual event horizons, are equivalent to bulk caustics through UV/IR mixing [12].

Where the bulk anti deSitter space connects to the compact 5-dimensional unit-sphere space, on the boundary CFT₄, is a Planck throat where the black-brane lives that acts like a wormhole throat for superluminal energy flow. Superluminal energy flow through the wormhole is unitary and only luminal inside the wormhole. The wormhole throat radius is the Planck length on the boundary electromagnetic black-brane. But the equivalent to the inverse fine structure constant is the Cauchy horizon and not the dual event horizon on the boundary.

Understanding how these higher dimensional effects appear from the point of view of the laboratory requires decomposing the (S⁵) 5-dimensional compact sphere (from type IIB string theory) into a more general Einstein space (M⁵→S²×S²×S¹ from type IIA string theory) or (M⁶→S²×S²×T² from M theory), as described by Duff et. al. [[15] M. Duff, H. Lu, and C. Pope, “AdS₅×S⁵ Untwisted”, arXiv:hep-th/9803061 v3, May 6, 1998] and incorporated herein by reference. The laboratory experimental results, as viewed in the (CFT₄) boundary space (S³), are caused by the disjoint union of two Planck scale spheres (S²×S²) separated by the Nyquist sample spacing. The circle (S¹) or torus (T²) connects the disjoint spheres in the higher dimensional Einstein space (M⁵) or (M⁶) and through the Nyquist spacing in the boundary space (S³). There are two paths between the spheres (S²×S²), one path through the boundary space (S³) and one path into one sphere (S²) and out the other sphere (S²). If oxidized to M-theory the circle (S¹) becomes the torus (T²) in a 6-dimensional Einstein space (M⁶). When the torus is lined up along the cosmic microwave background Doppler redshift direction, the electromagnetic average-energy as defined above, falls into one sphere, travels through the higher dimensional torus, and comes out the other sphere, 6 cm ahead of the path through the boundary space (S³). The two disjoint spheres (S²×S²) are wormhole mouths. Luminal energy flow through the wormhole only appears superluminal in the laboratory, and therefore preserves the dominant energy condition. The measured photon energy, defined using the photon energy equation, is constant because photon energy always moves at the vacuum speed of light through the background spacetime. For a tunneling photon propagating into the cosmic microwave background Doppler redshift direction, the background spacetime contains a Nyquist length wormhole. The gauge dual to the UV Planck-scale wormhole is the IR Nyquist-scale quasi-photon. The infinitely bright UV Cauchy surface associated with wormhole formation is censored by the Planck-scale electromagnetic black-brane event horizon. The IR electromagnetic caustic at the measured inverse fine structure constant is a holographic projection into the bulk AdS₅ spacetime. The IR cosmic compass technology is useful for probing UV string and M theory physics through UV/IR mixing [12].

Cosmic compass technology adds quasi photons to glueballs, so that now all of the standard-model massless-bosons have a useful geometric description. Glueballs are the large N limit as described by Maldacena [[16] J. Maldacena, “The Large N Limit of Superconformal field theories and supergravity”, Adv. Theor. Math. Phys. 2 (1998) 231, arXiv:hep-th/9711200 v3, Jan. 22, 1998] and quasi photons are at (N=1) as described above.

Accordingly, based on these theories it is possible to use the cosmic compass device described herein to measure the inverse fine structure constant, as well as a teaching tool to demonstrate many physical principles.

Although specific embodiments are disclosed herein, it is expected that persons skilled in the art can and will design alternative light velocity vector measurement systems that are within the scope of the following claims either literally or under the Doctrine of Equivalents.

What is claimed is:

1. A cosmic compass device for measuring the tunneling time of a wavepacket comprising:
a transmission source for generating a wavepacket, the wavepacket comprising a wavefront component;
a signal controller for generating a signal pulse;
a signal receiver for receiving the signal pulse;
a selective-transmission device comprising a quantum barrier defining
a transmission distance, said selective-transmission device being in signal communication with the transmission source, the signal controller, and the receiver such that the wavepacket is transmitted to the barrier and the wavefront component of the wavepacket tunnels through the barrier and across the transmission distance to the receiver causing superluminal group velocities;
a monitor in signal communication with the receiver for determining the centroid time for each of a plurality wavepacket peaks; and
an analyzer for computing the vector group velocity of light from the measured centroid times and determining the universal fine structure constant therefrom.

2. The cosmic compass device as described in claim 1, wherein the quantum barrier comprises a pair of transmission barriers positioned parallel to each other and separated by an air gap having a length.

3. The cosmic compass device as described in claim 2, wherein the pair of transmission barriers are tanks defining an internal volume capable of holding a liquid.

4. The cosmic compass device as described in claim 3, wherein the liquid is water.

5. The cosmic compass device as described in claim 2, wherein the length of the air gap can be adjusted such that the length of the air gap enhances the wavefront component of the wavepacket transmission.

6. The cosmic compass device as described in claim 1, wherein the transmitter comprises a pulse transmitter in signal communication with a transmission antenna.

7. The cosmic compass device as described in claim 6, wherein the antenna is a five element folded-dipole Yagi antenna.

8. The cosmic compass device as described in claim 1, wherein the transmitter further comprises a wavelength selector such that only desired radio wavelengths are transmitted by the transmitter.

9. The cosmic compass device as described in claim 1, wherein the receiver comprises a radio amplifier in signal communication with a receiver antenna.

10. The cosmic compass device as described in claim 9, wherein the antenna is a five element folded-dipole Yagi antenna.

11. The cosmic compass device as described in claim 1, wherein the apparatus is designed as a teaching tool for demonstrating a physical principle selected from the list consisting of dual bulk-AdS₅ space-time electromagnetic caustic physics, boundary electromagnetic Planck scale physics, and Cauchy horizon physics in string theory.

12. The cosmic compass device as described in claim 1, wherein the apparatus is designed as a teaching tool for demonstrating how holographic information is stored.

13. The cosmic compass device as described in claim 1, wherein the apparatus is designed as a teaching tool for demonstrating how holographic information is mapped into an IR bulk AdS₅ space-time defining a local electromagnetic caustic.

14. The cosmic compass device as described in claim 1, wherein the apparatus is designed as a teaching tool for demonstrating a Nyquist sample spacing in a bulk.

15. The cosmic compass device as described in claim 1, wherein the apparatus is designed as a teaching tool for demonstrating how the inverse fine structure constant equals a Cauchy horizon in a compact space.

16. The cosmic compass device as described in claim 1, wherein the apparatus is designed as a teaching tool for demonstrating how a superluminal energy flow is causal, unitary, and luminal through a warped space-time.

17. A method for measuring the inverse fine structure constant utilizing a cosmic compass as described in claim 1 to measure the centroid times and photon phase velocity, and bandlimit time flow with the RG to the caustic that is the inverse fine structure constant when tunneling is into the cosmic microwave background Doppler redshift direction.
